(19) United States
(12) Patent Application Publication
(10) Pub. No.: US 2026/0131440 A1
(43) Pub. Date: May 14, 2026

(54) Fastener Driving Machine

(71) Applicant: XIAO HUA DENG, Suzhou (CN)

(72) Inventor: XIAO HUA DENG, Suzhou (CN)

(21) Appl. No.: 18/942,800

(22) Filed: Nov. 11, 2024

(51) Int. Cl. B25C 1/06; F16H 1/28

(52) U.S. Cl. CPC B25C 1/06; F16H 1/28

(57) ABSTRACT

A fastener driving machine includes an energy storage unit, an impact unit, a rotational power unit, and a driving unit. The impact unit is used to drive the energy storage unit to store energy and can withstand the energy released by the energy storage unit to drive a fastener into a workpiece along a first direction. The impact unit includes a first mating structure and a second mating structure. The driving unit includes a first planetary gear assembly and a second planetary gear assembly driven by the rotational power unit. In the first stage of an energy storage process, the first planetary gear assembly is engaged with the first mating structure. In the second stage the energy storage process, the first planetary gear assembly is disengaged from the first mating structure, and the second planetary gear assembly is engaged with the second mating structure.

### TECHNICAL FIELD

The present application relates to the field of electric tools, specifically to a fastener driving machine.

### BACKGROUND ART

Generally, a fastener driving machine includes an energy storage unit, a driving unit, a rotational power unit, and an impact unit. The driving unit includes a plurality of first engaging teeth, and the impact unit includes a plurality of second engaging teeth. During the operation of the fastener driving machine, the plurality of first engaging teeth of the driving unit are engaged with the plurality of second engaging teeth of the impact unit. The driving unit drives the impact unit to move in a second direction so that the energy storage unit stores energy. Under the action of the energy released by the energy storage unit, the impact unit moves in a first direction to drive the fastener into the workpiece, wherein the first direction is opposite to the second direction. When a fastener jam occurs, the impact unit may not stop at a position where the impact unit can be correctly engaged with the driving unit, causing the fastener driving machine to fail to work properly.

Therefore, it is necessary to provide a new fastener driving machine.

### SUMMARY OF THE INVENTION

The present application provides a fastener driving machine that operates stably and smoothly.

On one hand, the present application provides a fastener driving machine, which includes:
An energy storage unit, used for storing energy;
An impact unit, used to drive the energy storage unit to store the energy and capable of withstanding the energy released by the energy storage unit to drive a fastener into a workpiece along a first direction, the impact unit including a first mating structure and a second mating structure arranged at different positions along an extending direction of the impact unit;
A rotational power unit;
A driving unit, including a first planetary gear assembly and a second planetary gear assembly driven by the rotational power unit; wherein
An energy storage process of the energy storage unit includes a first stage and a second stage. In the first stage, the first planetary gear assembly is engaged with the first mating structure, the first planetary gear assembly drives the impact unit to move, the impact unit drives the energy storage unit to store the energy. In the second stage, the first planetary gear assembly is disengaged from the first mating structure, and the second planetary gear assembly is engaged with the second mating structure, the second planetary gear assembly drives the impact unit to move, the impact unit drives the energy storage unit to store the energy.

On the other hand, the present application provides a fastener driving machine, which includes:
An energy storage unit, used for storing energy;
An impact unit, used to drive the energy storage unit to store the energy and capable of withstanding the energy released by the energy storage unit to drive a fastener into a workpiece along a first direction, the impact unit including a second engaging mechanism, the second engaging mechanism including a first mating structure and a second mating structure arranged at different positions along an extending direction of the impact unit;
A driving unit, capable of being engaged with the impact unit, the driving unit including a first engaging mechanism, the first engaging mechanism including a first engaging structure and a second engaging structure; wherein
An energy storage process of the energy storage unit includes a first stage and a second stage. In the first stage, the first engaging structure is engaged with the first mating structure, the driving unit drives the impact unit to move, the impact unit drives the energy storage unit to store the energy. In the second stage, the first engaging structure is disengaged from the first mating structure, and the second engaging structure is engaged with the second mating structure, the driving unit drives the impact unit to move, the impact unit drives the energy storage unit to store the energy.

In the present application, the driving unit includes a first engaging mechanism, the first engaging mechanism includes a first engaging structure and a second engaging structure. The impact unit includes a second engaging mechanism, the second engaging mechanism includes a first mating structure and a second mating structure. The first engaging structure can only be engaged with the first mating structure, and the second engaging structure can only be engaged with the second mating structure. An engagement between the first engaging structure and the first mating structure is independent of an engagement between the second engaging structure and the second mating structure, there will be no engaging errors or even jams.

### BRIEF DESCRIPTION OF THE DRAWINGS

FIG. 1 is a structural diagram of a partial structure of the fastener driving machine according to the first embodiment of the present application;

FIG. 2 is a structural diagram from one perspective of the partial structure of the fastener driving machine shown in FIG. 1;

FIG. 3 is a cross-sectional view along line A-A of the partial structure of the fastener driving machine shown in FIG. 2;

FIG. 4 is a structural diagram of a partial structure of the fastener driving machine shown in FIG. 1;

FIG. 5 is a structural diagram from one perspective of the partial structure of the fastener driving machine shown in FIG. 4;

FIG. 6 is a cross-sectional view along line B-B of the partial structure of the fastener driving machine shown in FIG. 5;

FIG. 7 is a structural diagram of a partial structure of the fastener driving machine shown in FIG. 4;

FIG. 8 shows various state diagrams of one working cycle of the fastener driving machine according to the first embodiment of the present application;

FIG. 9 shows various state diagrams of one working cycle of the fastener driving machine under a fastener jam condition according to the first embodiment of the present application;

FIG. 10 is a schematic structural diagram of the fastener driving machine according to the second embodiment of the present application;

FIG. 11 is a schematic structural diagram of the driving unit shown in FIG. 10;

FIG. 12 is a cross-sectional view along line C-C of the driving unit shown in FIG. 11;

FIG. 13 is a schematic diagram of the first engaging mechanism and the second engaging mechanism shown in FIG. 10;

FIG. 14 is a schematic diagram of a partial structure of the fastener driving machine shown in FIG. 10;

FIG. 15 is a cross-sectional view along line D-D of the partial structure shown in FIG. 14;

FIG. 16 is a cross-sectional view along line E-E of the partial structure shown in FIG. 15;

FIG. 17 is a schematic diagram showing various states in a working cycle of the fastener driving machine according to the second embodiment of the present application.

### DETAILED DESCRIPTION OF THE EMBODIMENTS

The exemplary embodiments will be described in detail below, examples of which are illustrated in the accompanying drawings. In the following description, unless otherwise indicated, the same or similar elements are denoted by the same numerals in different figures. The embodiments described in the following exemplary embodiments do not represent all embodiments consistent with the present application.

The terms used in the present application are merely for the purpose of describing particular embodiments and are not intended to limit the application. Unless otherwise defined, technical or scientific terms used herein should have the meanings commonly understood by those skilled in the art to which this invention belongs. The terms “first,” “second,” and the like used in the present application do not denote any order, quantity, or importance, but are merely used to distinguish different components. Likewise, terms such as “a” or “an” do not denote a limitation of quantity but indicate the presence of at least one. Terms like “multiple” or “several” mean two or more. Unless otherwise stated, terms such as “front,” “rear,” “lower,” and/or “upper” are used for convenience of description and are not limited to a position or spatial orientation. Terms like “include” or “comprise” indicate that the elements or objects preceding “include” or “comprise” cover the elements or objects and their equivalents listed after “include” or “comprise,” and do not exclude other elements or objects. Terms like “connect” or “couple” are not limited to physical or mechanical connections but may include electrical connections, whether direct or indirect. The singular forms “a,” “an,” “the,” and “this” used in the specification and the appended claims are intended to include plural forms unless the context clearly indicates otherwise. It should also be understood that the term “and/or” as used herein refers to any and all possible combinations of one or more of the associated listed items.

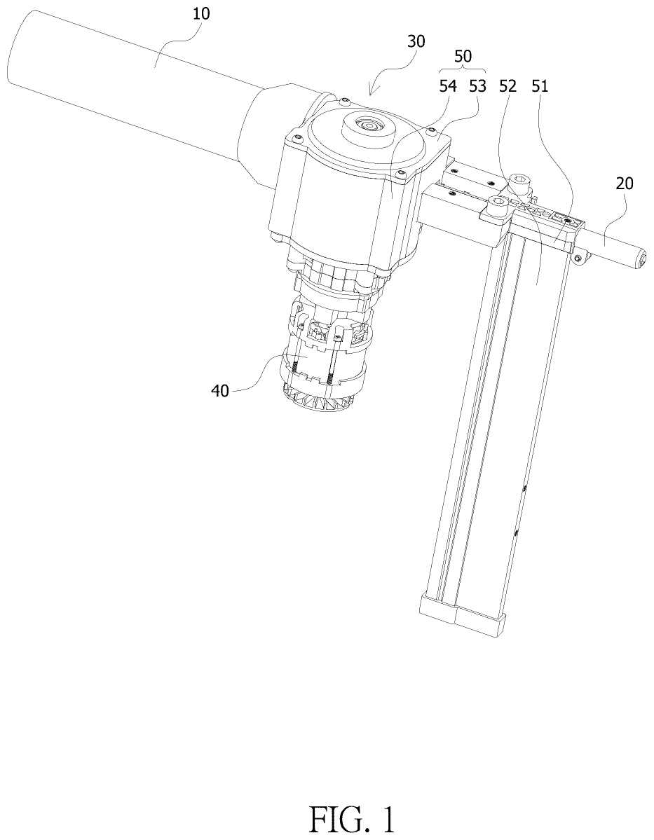

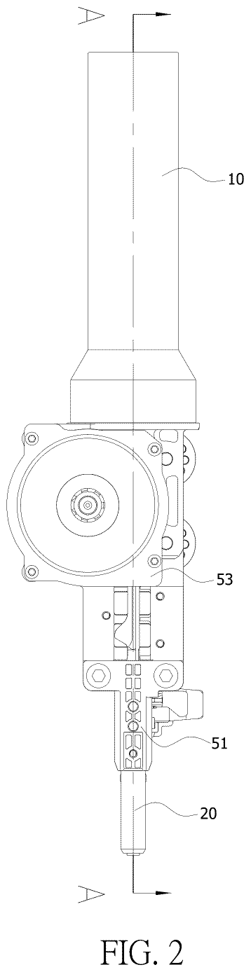

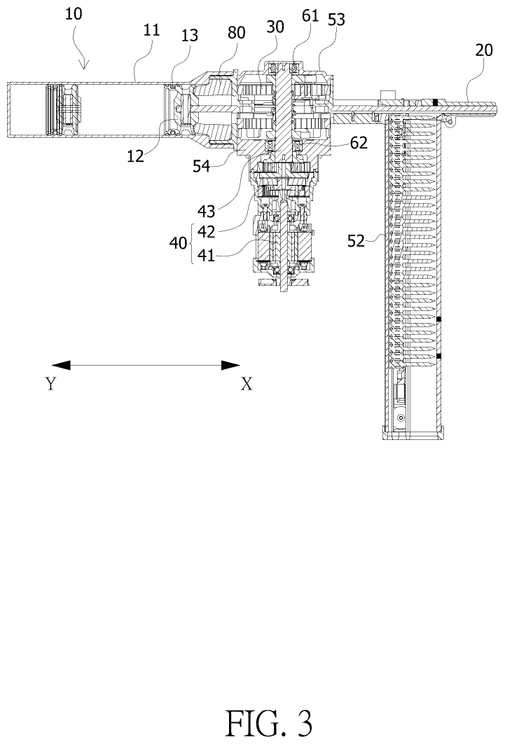

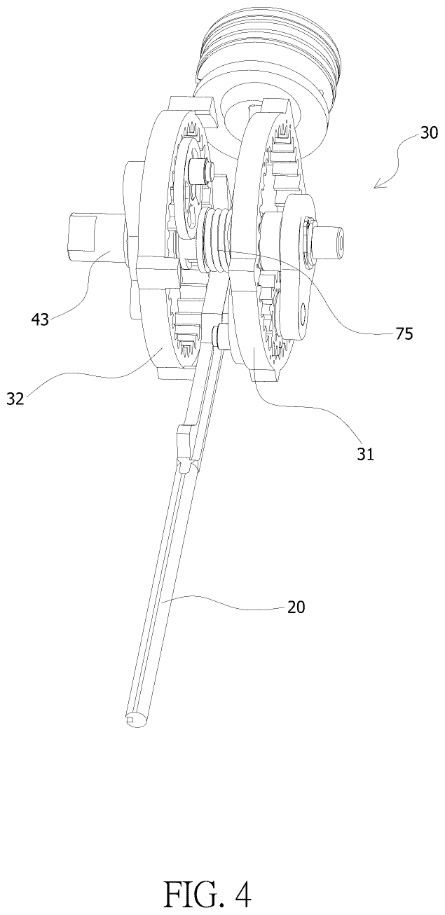

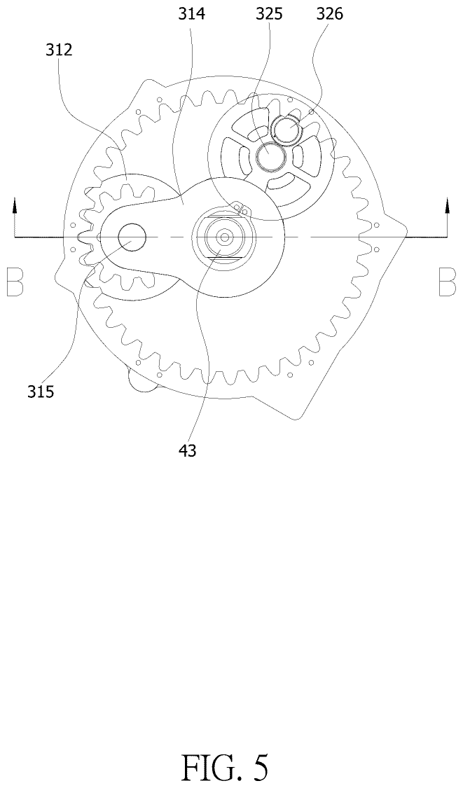

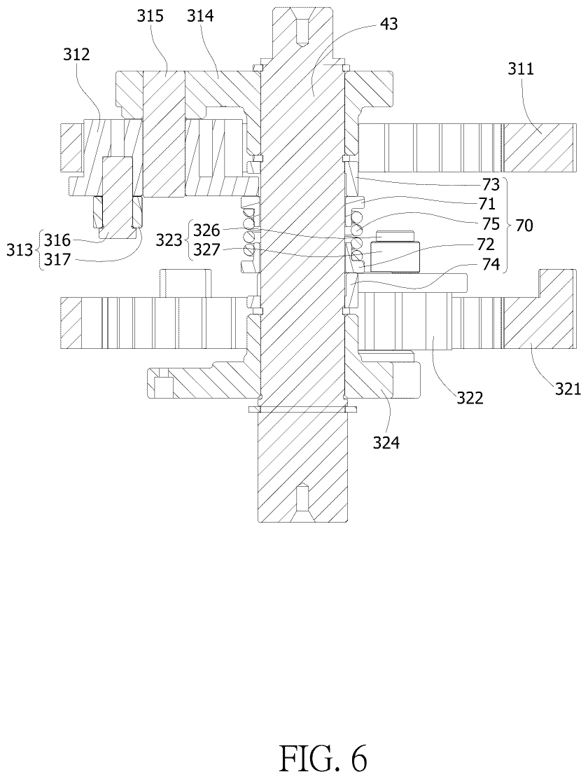

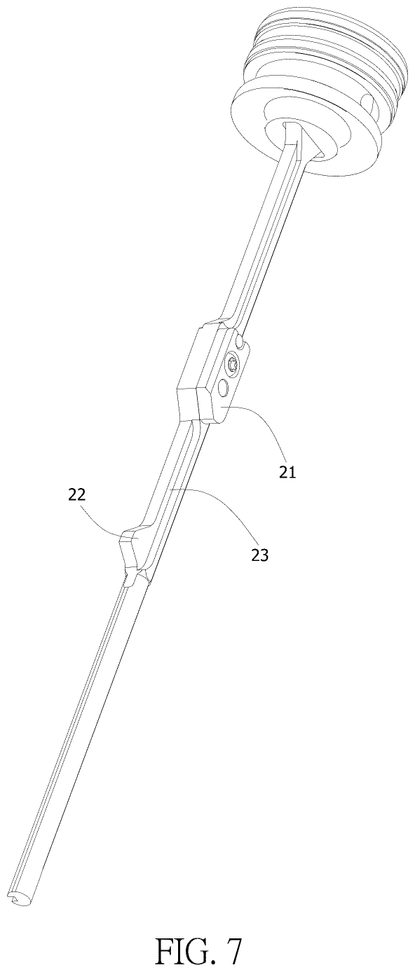

Please refer to FIGS. 1 to 7. The first embodiment of the present application provides a fastener driving machine, which includes an energy storage unit 10, an impact unit 20, a driving unit 30, a rotational power unit 40, and a supporting unit 50. The impact unit 20 is used to drive the energy storage unit 10 to store energy and can withstand the energy released by the energy storage unit to drive a fastener into a workpiece along a first direction X. The supporting unit 50 supports the energy storage unit 10, the impact unit 20, the driving unit 30 and the rotational power unit 40. The fastener driving machine includes a fastener guide plate 51 and a fastener storage clip 52. The fastener storage clip 52 is connected to the fastener guide plate 51 and contains fasteners (not shown in the figure). The fastener storage clip 52 can deliver fasteners to the fastener guide plate 51, which guides the fasteners, and the fasteners are driven into the workpiece by the impact unit 20. In this embodiment, the fasteners are nails, the fastener guide plate 51 is a nail guide plate, and the fastener storage clip 52 is a nail storage clip.

The energy storage unit 10 is a medium that can realize energy storage through displacement changes, such as air springs, mechanical springs, rubber elements, etc. In this embodiment, the energy storage unit 10 is an air spring, which includes a cylinder 11, a piston 12, and a sealing ring 13. The cylinder 11 and the piston 12 form a sealed space containing gas, sealed by the sealing ring 13 between the cylinder 11 and the piston 12. One end of the impact unit 20 is connected to the piston 12, and the other end of the impact unit 20 is used to drive the fastener into the workpiece. The impact unit 20 can move together with the piston 12. The energy storage unit 10 is used to store energy, and the driving unit 30 is cooperated with the impact unit 20, the driving unit 30 drives the impact unit 20 to move in a second direction Y, the impact unit 20 drives the energy storage unit 10 to store energy. When the energy storage unit 10 releases the energy, the impact unit 20 receives the energy and drives the fastener into the workpiece along the first direction X, wherein the first direction X is opposite to the second direction Y.

The rotational power unit 40 provides rotational power to the driving unit 30. The rotational power unit 40 includes a motor 41 and a gear transmission mechanism 42. The rotational speed and torque output by the motor 41 are transmitted to the driving unit 30 through the gear transmission mechanism 42. The gear transmission mechanism 42 is used to reduce rotational speed and increase torque. The gear transmission mechanism 42 includes one or more stages of planetary gear transmission; in this embodiment, the gear transmission mechanism 42 includes a three-stage planetary gear transmission. The gear transmission mechanism 42 also includes a one-way clutch. When the impact unit 20 is in a pre-compression state, after the motor 41 is powered off, the motor 41 will not reverse, causing the driving unit 30 to be disengaged from the impact unit 20.

The impact unit 20 includes an impact rod 23, a first mating structure 21 and a second mating structure 22. The first mating structure 21 and the second mating structure 22 are arranged on the same side of the impact rod 23. Along the extending direction of the impact rod 23, the first mating structure 21 and the second mating structure 22 are arranged at different positions. In this embodiment, the first mating structure 21 and the second mating structure 22 are respectively a first tooth and a second tooth arranged on the same side of the impact rod 23. In other embodiments, the first mating structure 21 and the second mating structure 22 are respectively a first groove and a second groove arranged on the same side of the impact rod 23.

The driving unit 30 includes a rotatable output shaft 43, a first planetary gear assembly 31 and a second planetary gear assembly 32. The first planetary gear assembly 31 and the second planetary gear assembly 32 distributed along the axial direction of the output shaft 43. The first planetary gear assembly 31 and the second planetary gear assembly 32 are oppositely arranged along the axial direction of the output shaft 43. In the arrangement direction of the first planetary gear assembly 31 and the second planetary gear assembly 32, the impact unit 20 is located between the first planetary gear assembly 31 and the second planetary gear assembly 32. The output shaft 43 is driven by the rotational power unit 40. The output shaft 43 penetrates at least part of the first planetary gear assembly 31 and at least part of the second planetary gear assembly 32; specifically, the first planetary gear assembly 31 and the second planetary gear assembly 32 are mounted on the output shaft 43. The energy storage process of the energy storage unit 10 includes a first stage and a second stage. In the first stage, the first planetary gear assembly 31 is engaged with the first mating structure 21, the first planetary gear assembly 31 drives the impact unit 20 to move, the impact unit 20 drives the energy storage unit 10 to store energy. In the second stage, the first planetary gear assembly 31 is disengaged from the first mating structure 21, and the second planetary gear assembly 32 is engaged with the second mating structure 22, the second planetary gear assembly 32 drives the impact unit 20 to move, the impact unit 20 drives the energy storage unit 10 to store energy. Specifically, in some embodiments, when the first planetary gear assembly 31 is disengaged from the first mating structure 21, the second planetary gear assembly 32 is engaged with the second mating structure 22, the second planetary gear assembly 32 drives the impact unit 20 to move, the impact unit 20 drives the energy storage unit 10 to store energy. In other embodiments, when the second planetary gear assembly 32 is engaged with the second mating structure 22, the first planetary gear assembly 31 has not been disengaged from the first mating structure 21; after a period of operation, the first planetary gear assembly 31 is disengaged from the first mating structure 21, and the second planetary gear assembly 32 is still engaged with the second mating structure 22 so that the impact unit 20 drives the energy storage unit 10 to store energy.

The first planetary gear assembly 31 includes a first ring gear 311, a first planetary gear 312 that revolves relative to the first ring gear 311 and a first pushing structure 313 connected to the first planetary gear 312, the first ring gear 311 is not rotatable, the first planetary gear assembly 31 further includes a first crank 314 connected to the output shaft 43 and capable of rotating with the output shaft 43. The second planetary gear assembly 32 includes a second ring gear 321, a second planetary gear 322 that revolves relative to the second ring gear 321 and a second pushing structure 323 connected to the second planetary gear 322, the second ring gear 321 is not rotatable, the second planetary gear assembly 32 further includes a second crank 324 connected to the output shaft 43 and capable of rotating with the output shaft 43. The first planetary gear 312 is engaged with the first ring gear 311, and the second planetary gear 322 is engaged with the second ring gear 321. The first planetary gear 312 is rotatably connected to the first crank 314 and capable of moving with the first crank 314, and the second planetary gear 322 is rotatably connected to the second crank 324 and capable of moving with the second crank 324. The first pushing structure 313 can rotate with the first planetary gear 312, and the second pushing structure 323 can rotate with the second planetary gear 322. The first pushing structure 313 is engaged with the first mating structure 21 to push the impact unit 20 to move a first distance along the second direction Y; the second pushing structure 323 is engaged with the second mating structure 22 to push the impact unit 20 to move a second distance along the second direction Y. The first distance and the second distance are superimposed to form a complete distance. The ratio of the number of teeth of the first ring gear 311 to the number of teeth of the first planetary gear 312 is 3:1, and the ratio of the number of teeth of the second ring gear 321 to the number of teeth of the second planetary gear 322 is also 3:1. The first crank 314 includes a first crankshaft 315, and the second crank 324 includes a second crankshaft 325. The first planetary gear 312 is rotatably mounted on the first crankshaft 315, and the second planetary gear 322 is rotatably mounted on the second crankshaft 325. The line connecting the center of the first crankshaft 315 with the center of the output shaft 43 is defined as the first line, and the line connecting the center of the second crankshaft 325 with the center of the output shaft 43 is defined as the second line. The angle between the projection of the first line along the extending direction of the output shaft 43 and the projection of the second line along the extending direction of the output shaft 43 is 120°.

The engaging area between the first pushing structure 313 and the first mating structure 21 is defined as the first engaging area, and the engaging area between the second pushing structure 323 and the second mating structure 22 is defined as the second engaging area. The projection of the first engaging area along the extending direction of the impact rod 23 is defined as the first projection, and the projection of the second engaging area along the extending direction of the impact rod 23 is defined as the second projection. The first projection and the second projection do not overlap. The projection of the first mating structure 21 along the extending direction of the impact rod 23 and the projection of the second mating structure 22 along the extending direction of the impact rod 23 do not overlap or partially overlap. This design ensures that the first pushing structure 313 of the first planetary gear assembly 31 can only be engaged with the first mating structure 21 of the impact unit 20, and the second pushing structure 323 of the second planetary gear assembly 32 can only be engaged with the second mating structure 22 of the impact unit 20; an engagement between the first pushing structure 313 and the first mating structure 21 is independent of an engagement between the second pushing structure 323 and the second mating structure 22. In this embodiment, the first mating structure 21 is installed on the impact rod 23 by positioning with a cylindrical pin and fastening with a screw, while the second mating structure 22 is integrally formed on the impact rod 23. In other embodiments, both the first mating structure 21 and the second mating structure 22 can be integrally formed on the impact rod 23.

The supporting unit 50 also includes an upper cover 53 and a base 54, the output shaft 43 is located between the upper cover 53 and the base 54. Both ends of the output shaft 43 are supported by a first bearing 61 and a second bearing 62, respectively. Specifically, the first end of the output shaft 43 is supported by the first bearing 61, the first bearing 61 is supported between the upper cover 53 and the first end of the output shaft 43, and the second end of the output shaft 43 is supported by the second bearing 62, the second bearing 62 is supported between the base 54 and the second end of the output shaft 43. It should be noted that the gear transmission mechanism 42 is not necessary; when the torque output by the motor 41 is sufficient, the motor shaft can be directly used as the output shaft 43.

Both the first ring gear 311 and the second ring gear 321 are fixedly arranged in the accommodating space formed by the base 54 and the upper cover 53. The first ring gear 311 and the second ring gear 321 are oppositely arranged along the axial direction of the output shaft 43. The first pushing structure 313 is eccentrically connected to the first planetary gear 312 and protrudes from a side, close to the second ring gear 321, of the first planetary gear 312. The second pushing structure 323 is eccentrically connected to the second planetary gear 322 and protrudes from a side, close to the first ring gear 311, of the second planetary gear 322.

The first pushing structure 313 includes a first pin shaft 316 and a first shaft sleeve 317 sleeved on the first pin shaft 316. The second pushing structure 323 includes a second pin shaft 326 and a second shaft sleeve 327 sleeved on the second pin shaft 326. The first pin shaft 316 is eccentrically connected to the first planetary gear 312, and the second pin shaft 326 is eccentrically connected to the second planetary gear 322. When the first mating structure 21 and the second mating structure 22 are respectively the first tooth and the second tooth, the first pushing structure 313 is engaged with the first mating structure (first tooth) 21, and the second pushing structure 323 is engaged with the second mating structure (second tooth) 22. When the first mating structure 21 and the second mating structure 22 are respectively the first groove and the second groove, the first pushing structure 313 is engaged with the first mating structure (first groove) 21, and the second pushing structure 323 is engaged with the second mating structure (second groove) 22. The shaft sleeves (first shaft sleeve 317 and second shaft sleeve 327) are provided to reduce friction when the pushing structures (first pushing structure 313 and the second pushing structure 323) are engaged with the mating structures (first mating structure 21 and second mating structure 22), the shaft sleeves are not necessary for the realization of the function.

The fastener driving machine also includes a supporting mechanism 70 arranged between the first planetary gear assembly 31 and the second planetary gear assembly 32. The supporting mechanism 70 is mounted on the output shaft 43 and abuts against the first planetary gear 312 and the second planetary gear 322. Specifically, the supporting mechanism 70 includes a spring 75, a first pressing sleeve 71, a second pressing sleeve 72, a first supporting sleeve 73 and a second supporting sleeve 74. The spring 75, the first pressing sleeve 71, the second pressing sleeve 72, the first supporting sleeve 73 and the second supporting sleeve 74 are all sleeved and mounted on the output shaft 43. The spring 75 is arranged between the first pressing sleeve 71 and the second pressing sleeve 72. The side, away from the spring 75, of the first pressing sleeve 71 abuts against the first planetary gear 312. The side, away from the spring 75, of the second pressing sleeve 72 abuts against the second planetary gear 322. The first pressing sleeve 71 is supported between the spring 75 and the first supporting sleeve 73, and the second pressing sleeve 72 is supported between the spring 75 and the second supporting sleeve 74. The first pressing sleeve 71, the second pressing sleeve 72 and the spring 75 are provided to prevents the planetary gears from escaping axially from the crankshaft. The first supporting sleeve 73 is used to support the first pressing sleeve 71, and the second supporting sleeve 74 is used to support the second pressing sleeve 72.

The fastener driving machine also includes a buffer member 80 arranged between the piston 12 and the base 54. When the piston 12 is not driven by the impact unit 20, the piston 12 is attached to the buffer member 80; at this time, the position of the impact unit 20 is called the bottom dead center. When the piston 12 is driven by the impact unit 20 to the limiting position, the position of the impact unit 20 is called the top dead center.

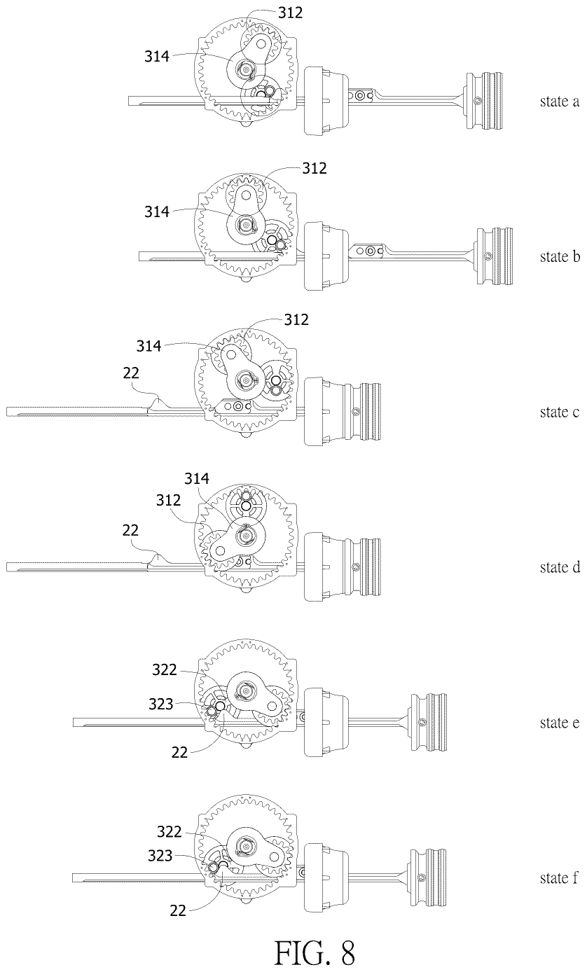

Please refer to the states a, b, c, d, e, and f in FIG. 8. The states from a to f correspond to one working cycle:

In state a, which is the initial state of the entire working cycle, the impact unit 20 is in the pre-compression position. The impact unit 20 drives the piston 12 to move, compressing the energy storage unit 10. The second pushing structure 323 of the second planetary gear assembly 32 is engaged with the second mating structure 22 of the impact unit 20, while the first pushing structure 313 of the first planetary gear assembly 31 is not engaged with the first mating structure 21 of the impact unit 20. The output shaft 43 continues to rotate counterclockwise, driving the first crank 314 and the second crank 324 to rotate. The second pushing structure 323 of the second planetary gear assembly 32 continues to push the impact unit 20, which in turn drives the piston 12 to move until state b is reached, where the impact unit 20 is at the top dead center.

The output shaft 43 continues to rotate counterclockwise; the second pushing structure 323 of the second planetary gear assembly 32 is disengaged from the second mating structure 22 of the impact unit 20. Under the action of the energy released by the energy storage unit 10, the impact unit 20 drives the fastener into the workpiece along the first direction X. At this time, the piston 12 reaches to the bottom dead center and is attached to the buffer member 80, as shown in state c.

The output shaft 43 continues to rotate counterclockwise. The first pushing structure 313 of the first planetary gear assembly 31 is not engaged with the first mating structure 21 of the impact unit 20, and the second pushing structure 323 of the second planetary gear assembly 32 is not engaged with the second mating structure 22 of the impact unit 20. After a certain angle of no-load rotation, the first pushing structure 313 of the first planetary gear assembly 31 begins to be engaged with the first mating structure 21 of the impact unit 20, as shown in state d.

The output shaft 43 continues to rotate counterclockwise; the first pushing structure 313 of the first planetary gear assembly 31 pushes the impact unit 20, which in turn drives the piston 12 to move until state e is reached. At this time, the first pushing structure 313 of the first planetary gear assembly 31 will be disengaged from the first mating structure 21 of the impact unit 20, and the second pushing structure 323 of the second planetary gear assembly 32 will begin to be engaged with the second mating structure 22 of the impact unit 20. The output shaft 43 continues to rotate counterclockwise; the first pushing structure 313 of the first planetary gear assembly 31 is disengaged from the first mating structure 21 of the impact unit 20, and the second pushing structure 323 of the second planetary gear assembly 32 is engaged with the second mating structure 22 of the impact unit 20 to continue to push the impact unit 20. The impact unit 20 drives the piston 12 to move, as shown in state f. The output shaft 43 continues to rotate counterclockwise; the second pushing structure 323 of the second planetary gear assembly 32 is engaged with the second mating structure 22 of the impact unit 20 to push the impact unit 20 back to the pre-compression position, completing one working cycle.

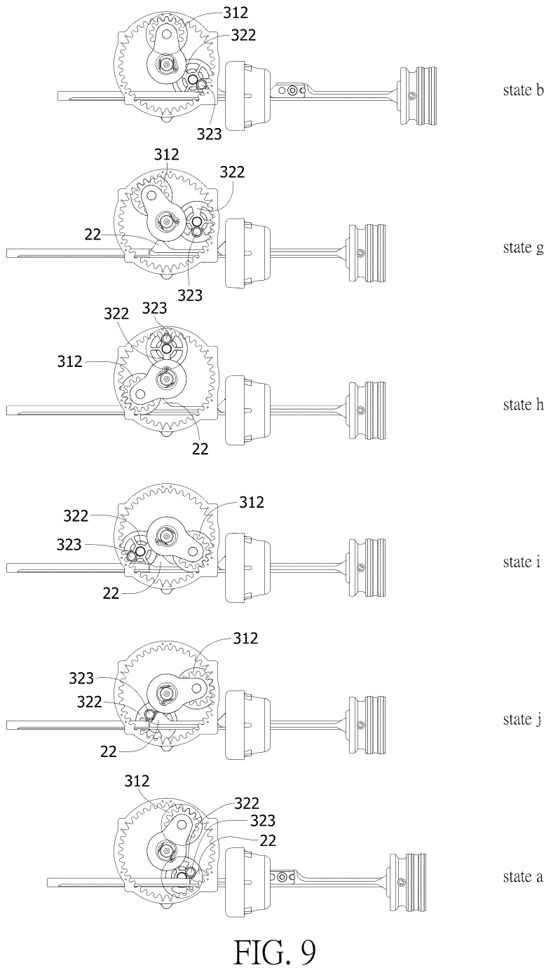

Please refer to FIG. 9. The output shaft 43 rotates counterclockwise, driving the first crank 314 and the second crank 324 to rotate. The second pushing structure 323 of the second planetary gear assembly 32 continues to push the impact unit 20, which in turn drives the piston 12 to move until state b is reached, where the impact unit 20 is at the top dead center. The output shaft 43 continues to rotate counterclockwise; the second pushing structure 323 of the second planetary gear assembly 32 is disengaged from the second mating structure 22 of the impact unit 20. Under the action of the energy released by the energy storage unit 10, the impact unit 20 drives the fastener into the workpiece along the first direction X. When fastener is stuck for some reason, the fastener is stuck in the fastener guide plate 51, and at this time, the impact unit 20 may stop at any position along the first direction X, as shown in state g.

After the fastener is stuck, the output shaft 43 continues to rotate counterclockwise; the first pushing structure 313 of the first planetary gear assembly 31 reaches to the position of the second mating structure 22 of the impact unit 20, as shown in state h. Since the first pushing structure 313 of the first planetary gear assembly 31 and the second mating structure 22 of the impact unit 20 are distributed at different positions along the axial direction of the output shaft 43, the first pushing structure 313 and the second mating structure 22 cannot be engaged with each other. At this time, the first planetary gear assembly 31 and the second planetary gear assembly 32 remain in a no-load state. The output shaft 43 continues to rotate counterclockwise; the second pushing structure 323 of the second planetary gear assembly 32 reaches to the position of the second mating structure 22 of the impact unit 20. The second pushing structure 323 of the second planetary gear assembly 32 is about to be engaged with the second mating structure 22 of the impact unit 20, as shown in state i. The output shaft 43 continues to rotate counterclockwise; the second pushing structure 323 of the second planetary gear assembly 32 is engaged with the second mating structure 22 of the impact unit 20 to push the impact unit 20. The impact unit 20 drives the piston 12 to move, as shown in state j. The output shaft 43 continues to rotate counterclockwise; the second pushing structure 323 of the second planetary gear assembly 32 is engaged with the second mating structure 22 of the impact unit 20 to push the impact unit 20 back to the pre-compression position, returning to the initial state a.

In this embodiment, the driving unit 30 includes the first planetary gear assembly 31 and the second planetary gear assembly 32, which are distributed along the axial direction of the output shaft 43. The first pushing structure 313 of the first planetary gear assembly 31 can only be engaged with the first mating structure 21 of the impact unit 20, and the second pushing structure 323 of the second planetary gear assembly 32 can only be engaged with the second mating structure 22 of the impact unit 20. An engagement between the first pushing structure 313 and the first mating structure 21 is independent of an engagement between the second pushing structure 323 and the second mating structure 22, there will be no engaging errors or even jams.

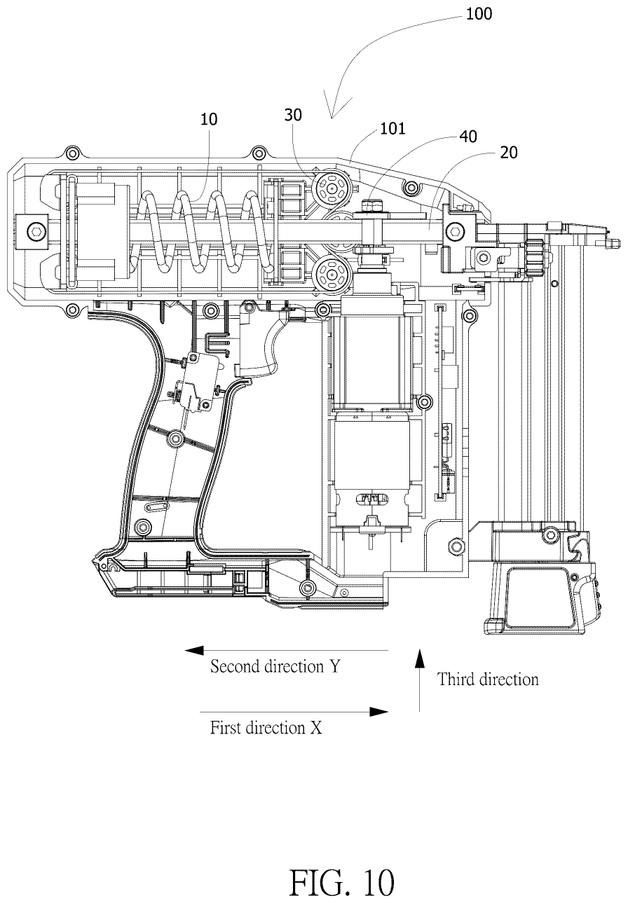

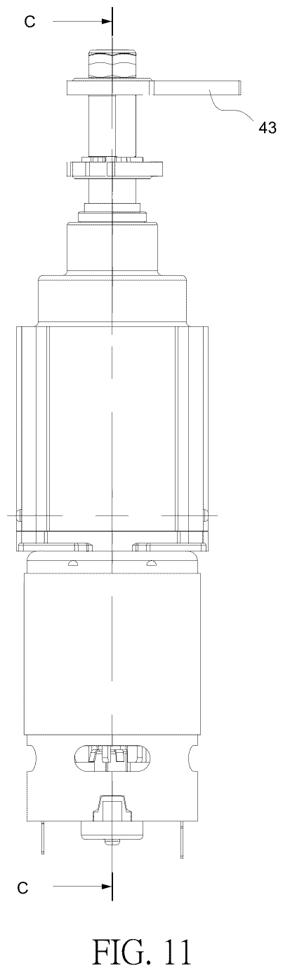

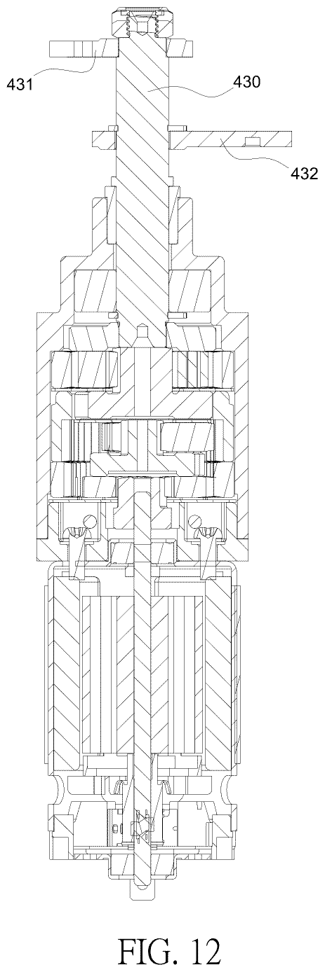

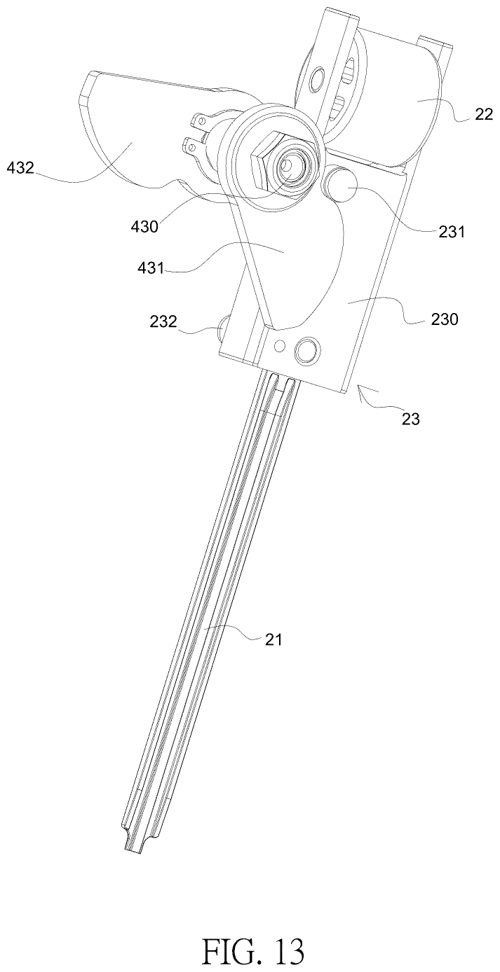

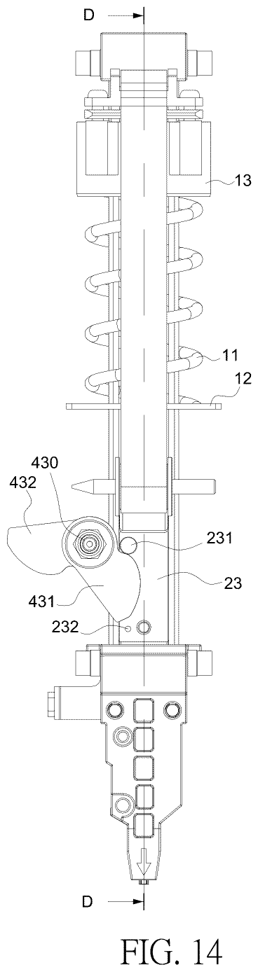

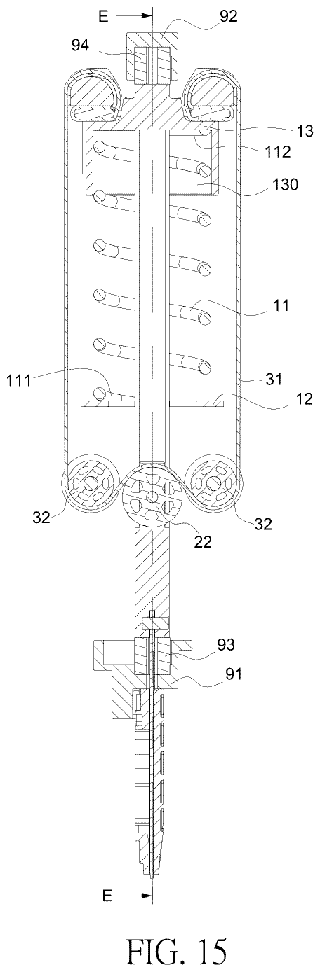

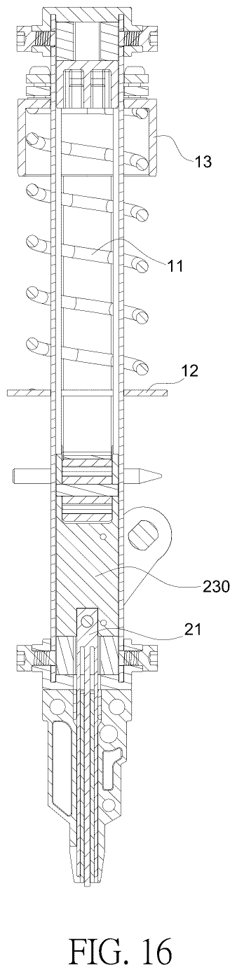

Please refer to FIGS. 10 to 17. The second embodiment of the present application provides a fastener driving machine, which includes a housing 101, an energy storage unit 10, an impact unit 20, a transmission unit 30 and a driving unit 40. The energy storage unit 10, the impact unit 20, the transmission unit 30 and the driving unit 40 are mounted in the housing 101. The transmission unit 30 connects the energy storage unit 10 with the impact unit 20. The energy storage unit 10 has an energy storage state and an energy release state. The impact unit 20 is used to drive the energy storage unit 10 to store energy and can withstand the energy released by the energy storage unit 10 to drive the fastener into the workpiece along the first direction X.

The driving unit 40 can be engaged with the impact unit 20. The driving unit 40 includes a first engaging mechanism 43, which includes a first engaging structure 431 and a second engaging structure 432. The impact unit 20 includes a second engaging mechanism 23, a firing pin 21 and a driving wheel 22. The firing pin 21 and the driving wheel 22 are connected to the second engaging mechanism 23. The second engaging mechanism 23 also includes a base 230, the base 230 is connected with the firing pin 21 via a pin, allowing the base 230 and the firing pin 21 to move together. The firing pin 21 is used to drive the fastener into the workpiece along the first direction X. The driving wheel 22 is mounted on the base 230 via a pin and can rotate around the pin. The driving wheel 22 is connected to the transmission unit 30, thereby driving the energy storage unit 10 to store energy.

The second engaging mechanism 23 includes a first mating structure 231 and a second mating structure 232 arranged on the base 230. Along the extending direction of the impact unit 20, the first mating structure 231 and the second mating structure 232 are arranged at different positions. The energy storage process of the energy storage unit 10 includes a first stage and a second stage. In the first stage, the first engaging structure 431 is engaged with the first mating structure 231, the driving unit 40 drives the impact unit 20 to move, the impact unit 20 drives the energy storage unit 10 to store energy. In the second stage, the first engaging structure 431 is disengaged from the first mating structure 231, and the second engaging structure 432 is engaged with the second mating structure 232, the driving unit 40 drives the impact unit 20 to move, the impact unit 20 drives the energy storage unit 10 to store energy.

Specifically, in the first stage, the first engaging structure 431 is engaged with the first mating structure 231 so that the driving unit 40 drives the impact unit 20 to move in the second direction Y. In the second stage, the first engaging structure 431 is disengaged from the first mating structure 231, and the second engaging structure 432 is engaged with the second mating structure 232 so that the driving unit 40 drives the impact unit 20 to move in the second direction Y. The first engaging structure 431 is a first cam, and the second engaging structure 432 is a second cam. The first mating structure 231 is a first pin shaft, and the second mating structure 232 is a second pin shaft. The first mating structure (first pin shaft) 231 is mounted on the base 230, and the second mating structure (second pin shaft) 232 is mounted on the base 230. The first engaging structure (first cam) 431 is engaged with the first mating structure (first pin shaft) 231, and the second engaging structure (second cam) 432 is engaged with the second mating structure (second pin shaft) 232.

The first engaging mechanism 43 also includes an output shaft 430. Both the first engaging structure 431 and the second engaging structure 432 are mounted on the output shaft 430 and rotate with the output shaft 430. The output shaft 430 penetrates at least part of the first engaging structure 431 and at least part of the second engaging structure 432. The first engaging structure 431 and the second engaging structure 432 are misaligned along the axial direction of the output shaft 430. During the rotation of the output shaft 430, the first engaging structure 431 is periodically engaged with or disengaged from the first mating structure 231, and the second engaging structure 432 is periodically engaged with or disengaged from the second mating structure 232. In one rotating period of the output shaft 430, the rotating angle of the first engaging structure 431 is less than 180° during a process of the first engaging structure 431 is maintaining an engagement with the first mating structure 231, and the rotating angle of the second engaging structure 432 is less than 180°during a process of the second engaging structure 432 is maintaining an engagement with the second mating structure 232.

The energy storage unit 10 includes a spring 11, a baffle plate 12, and an end cover 13. The spring 11 is arranged between the end cover 13 and the baffle plate 12. The baffle plate 12 is fixedly installed inside the housing 101. The spring 11 includes a fixed end 111 and a movable end 112. The movable end 112 can move relative to the fixed end 111. The fixed end 111 of the spring 11 is fixed to the baffle plate 12, and the movable end 112 of the spring 11 is accommodated within the accommodating space 130 formed by the end cover 13.

The transmission unit 30 includes a conveyor belt 31 and two fixed pulleys 32. The two fixed pulleys 32 are mounted inside the housing 101. The conveyor belt 31 is mounted on the two fixed pulleys 32. The conveyor belt 31 connects the driving wheel 22 of the impact unit 20 and the end cover 13 of the energy storage unit 10.

The fastener driving machine 100 includes a first base 91 and a second base 92 installed inside the housing 101. The fastener driving machine 100 also includes a first buffer member 93 installed inside the first base 91 and a second buffer member 94 installed inside the second base 92. After the impact unit 20 moves along the first direction X to drive the fastener into the workpiece, the impact unit 20 strikes the first buffer member 93, and the end cover 13 strikes the second buffer member 94.

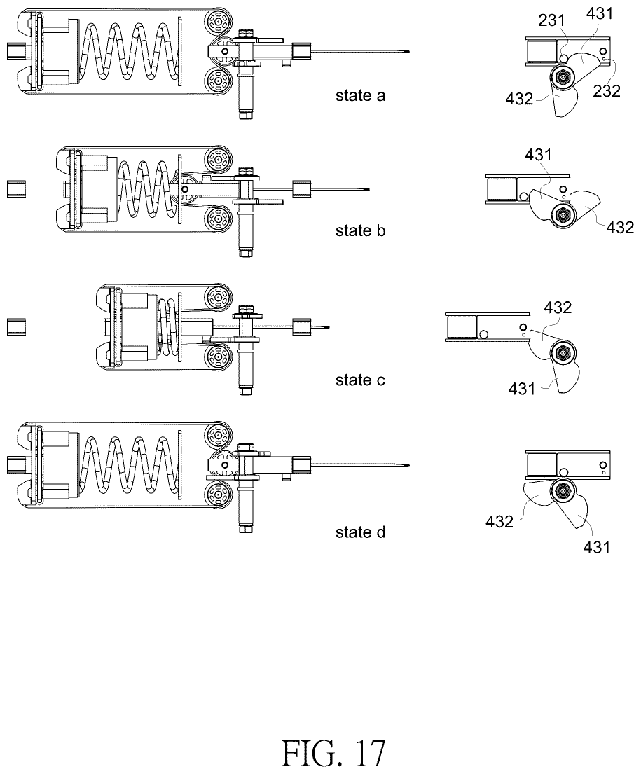

Below, in conjunction with FIG. 17, the working principle of the fastener driving machine 100 in this embodiment is explained. The states a, b, c, and d in FIG. 17 correspond to one working cycle.

The output shaft 430 rotates counterclockwise to the position shown in state a. At this time, the first engaging structure (first cam) 431 of the first engaging mechanism 43 of the driving unit 40 is about to be engaged with the first mating structure (first pin shaft) 231 of the second engaging mechanism 23 of the impact unit 20. The output shaft 430 continues to rotate counterclockwise, and the first engaging structure (first cam) 431 is engaged with the first mating structure (first pin shaft) 231. The driving unit 40 drives the impact unit 20 to move along the second direction Y. The impact unit 20 exerts a force along the second direction Y on the conveyor belt 31. After passing through the fixed pulleys 32, the conveyor belt 31 exerts a force along the first direction X on the movable end 112 of the spring 11 of the energy storage unit 10, causing the spring 11 to be compressed along the first direction X (the movable end 112 of the spring 11 moves along the first direction X, while the fixed end 111 of the spring 11 is connected to the baffle plate 12, the baffle plate 12 is fixed to the housing 101).

The output shaft 430 continues to rotate counterclockwise; the second engaging structure (second cam) 432 of the first engaging mechanism 43 of the driving unit 40 is engaged with the second mating structure (second pin shaft) 232 of the second engaging mechanism 23 of the impact unit 20, while the first engaging structure (first cam) 431 is disengaged from the first mating structure (first pin shaft) 231, as shown in state b. The driving unit 40 continues to drive the impact unit 20 to move along the second direction Y. The impact unit 20 continues to exert a force in the first direction X on the movable end 112 of the spring 11 of the energy storage unit 10 through the transmission unit 30, so that the spring 11 continues to be compressed in the first direction X.

The output shaft 430 continues to rotate counterclockwise; the second engaging structure (second cam) 432 is engaged with the second mating structure (second pin shaft) 232, the driving unit 40 drives the impact unit 20 to move to the top dead center, as shown in state c. At the same time, the impact unit 20 continues to compress the spring 11 along the first direction X through the transmission unit 30, completing energy storage.

The output shaft 430 continues to rotate counterclockwise; the second engaging structure (second cam) 432 is disengaged from the second mating structure (second pin shaft) 232. The spring 11 is stretched along the second direction Y, exerting a force in the second direction Y on the conveyor belt 31. After passing through the fixed pulleys 32, the conveyor belt 31 exerts a force in the first direction X on the impact unit 20, the impact unit 20 moves along the first direction X to drive the fastener into the workpiece.

After the fastener has been driven into the workpiece, the impact unit 20 strikes the first buffer member 93, and the end cover 13 connected to the movable end 112 of the spring 11 strikes the second buffer member 94. The first buffer member 93 absorbs the residual energy of the impact unit 20, and the second buffer member 94 absorbs the residual energy of the energy storage unit 10, as shown in state d. The output shaft 430 continues to rotate counterclockwise, and after rotating a certain angle, the first engaging structure (first cam) 431 of the first engaging mechanism 43 of the driving unit 40 can be engaged with the first mating structure (first pin shaft) 231 of the second engaging mechanism 23 of the impact unit 20 again, returning to the state a.

In this embodiment, the driving unit 40 includes the first engaging mechanism 43, which includes a first engaging structure 431 and a second engaging structure 432. The impact unit 20 includes the second engaging mechanism 23, which includes a first mating structure 231 and a second mating structure 232. The first engaging structure 431 can only be engaged with the first mating structure 231, and the second engaging structure 432 can only be engaged with the second mating structure 232. An engagement between the first engaging structure 431 and the first mating structure 231 is independent of an engagement between the second engaging structure 432 and the second mating structure 232, there will be no engaging errors or even jams.

The above descriptions are merely preferred embodiments of the present application and are not intended to limit the application in any form. Although the present application has been disclosed above through preferred embodiments, it is not intended to limit the application. Any person skilled in the art can make slight modifications or equivalent changes to the disclosed technical content without departing from the scope of the technical solutions of the present application. Any simple modifications, equivalent changes, and alterations made to the above embodiments according to the technical essence of the present application are still within the scope of the technical solutions of the present application.

I claim:

1. A fastener driving machine, comprising:
an energy storage unit, used for storing energy;
an impact unit, used to drive the energy storage unit to store the energy and capable of withstanding the energy released by the energy storage unit to drive a fastener into a workpiece along a first direction, the impact unit comprising a first mating structure and a second mating structure arranged at different positions along an extending direction of the impact unit;
a rotational power unit;
a driving unit, comprising a first planetary gear assembly and a second planetary gear assembly driven by the rotational power unit;
wherein an energy storage process of the energy storage unit comprises a first stage and a second stage, in the first stage, the first planetary gear assembly is engaged with the first mating structure, the first planetary gear assembly drives the impact unit to move, the impact unit drives the energy storage unit to store the energy; in the second stage, the first planetary gear assembly is disengaged from the first mating structure, and the second planetary gear assembly is engaged with the second mating structure, the second planetary gear assembly drives the impact unit to move, the impact unit drives the energy storage unit to store the energy.

2. The fastener driving machine according to claim 1, wherein at the same time as the first planetary gear assembly is disengaged from the first mating structure, the second planetary gear assembly is engaged with the second mating structure.

3. The fastener driving machine according to claim 1, wherein the driving unit comprises a rotatable output shaft, and the first planetary gear assembly and the second planetary gear assembly are distributed along an axial direction of the output shaft; the first planetary gear assembly comprises a first ring gear, a first planetary gear that revolves relative to the first ring gear and a first pushing structure connected to the first planetary gear, the first ring gear is not rotatable; the second planetary gear assembly comprises a second ring gear, a second planetary gear that revolves relative to the second ring gear and a second pushing structure connected to the second planetary gear, the second ring gear is not rotatable; the first planetary gear is engaged with the first ring gear, and the second planetary gear is engaged with the second ring gear, the first pushing structure is engaged with the first mating structure to push the impact unit, and the second pushing structure is engaged with the second mating structure to push the impact unit.

4. The fastener driving machine according to claim 3, wherein an engaging area between the first pushing structure and the first mating structure is defined as a first engaging area, and an engaging area between the second pushing structure and the second mating structure is defined as a second engaging area, a projection of the first engaging area along the extending direction of the impact unit is defined as a first projection, and a projection of the second engaging area along the extending direction of the impact unit is defined as a second projection, the first projection and the second projection do not overlap.

5. The fastener driving machine according to claim 3, wherein the first ring gear and the second ring gear are oppositely arranged along the axial direction of the output shaft, the first pushing structure is eccentrically connected to the first planetary gear, and the second pushing structure is eccentrically connected to the second planetary gear.

6. The fastener driving machine according to claim 5, wherein the first pushing structure comprises a first pin shaft, and the second pushing structure comprises a second pin shaft, the first pin shaft is eccentrically connected to the first planetary gear, and the second pin shaft is eccentrically connected to the second planetary gear.

7. The fastener driving machine according to claim 1, wherein the impact unit further comprises an impact rod, the first mating structure and the second mating structure are respectively a first tooth and a second tooth arranged on the same side of the impact rod, a projection of the first tooth along an extending direction of the impact rod and a projection of the second tooth along the extending direction of the impact rod do not overlap or partially overlap.

8. The fastener driving machine according to claim 3, wherein the first planetary gear assembly further comprises a first crank connected to the output shaft and capable of rotating with the output shaft, the first planetary gear is rotatably connected to the first crank and capable of moving with the first crank, the second planetary gear assembly further comprises a second crank connected to the output shaft and capable of rotating with the output shaft, the second planetary gear is rotatably connected to the second crank and capable of moving with the second crank.

9. The fastener driving machine according to claim 8, wherein the first crank comprises a first crankshaft, and the second crank comprises a second crankshaft, the first planetary gear is rotatably mounted on the first crankshaft, and the second planetary gear is rotatably mounted on the second crankshaft.

10. The fastener driving machine according to claim 9, wherein a line connecting a center of the first crankshaft with a center of the output shaft is defined as a first line, and a line connecting a center of the second crankshaft and the center of the output shaft is defined as a second line, an angle between a projection of the first line along an extending direction of the output shaft and a projection of the second line along the extending direction of the output shaft is 120 degrees.

11. The fastener driving machine according to claim 3, wherein the fastener driving machine further comprises a supporting mechanism arranged between the first planetary gear assembly and the second planetary gear assembly, the supporting mechanism is mounted on the output shaft and abuts against the first planetary gear and the second planetary gear.

12. The fastener driving machine according to claim 3, wherein a ratio of the number of teeth of the first ring gear to the number of teeth of the first planetary gear is 3 to 1, and a ratio of the number of teeth of the second ring gear to the number of teeth of the second planetary gear is 3 to 1.

13. The fastener driving machine according to claim 1, wherein the impact unit is located between the first planetary gear assembly and the second planetary gear assembly in an arrangement direction of the first planetary gear assembly and the second planetary gear assembly.

14. The fastener driving machine according to claim 1, wherein the impact unit further comprises an impact rod, and the first mating structure and the second mating structure are arranged on the same side of the impact rod; along an extending direction of the impact rod, the first mating structure and the second mating structure are arranged at different positions; the first mating structure is installed on the impact rod by positioning with a cylindrical pin and fastening with a screw.

15. A fastener driving machine, comprising:
an energy storage unit, used for storing energy;
an impact unit, used to drive the energy storage unit to store the energy and capable of withstanding the energy released by the energy storage unit to drive a fastener into a workpiece along a first direction, the impact unit comprising a second engaging mechanism, the second engaging mechanism comprising a first mating structure and a second mating structure arranged at different positions along an extending direction of the impact unit;
a driving unit, capable of being engaged with the impact unit, the driving unit comprising a first engaging mechanism, the first engaging mechanism comprising a first engaging structure and a second engaging structure;
wherein an energy storage process of the energy storage unit comprises a first stage and a second stage, in the first stage, the first engaging structure is engaged with the first mating structure, the driving unit drives the impact unit to move, the impact unit drives the energy storage unit to store the energy; in the second stage, the first engaging structure is disengaged from the first mating structure, and the second engaging structure is engaged with the second mating structure, the driving unit drives the impact unit to move, the impact unit drives the energy storage unit to store the energy.

16. The fastener driving machine according to claim 15, wherein the first engaging structure is a first planetary gear assembly or a first cam, and the second engaging structure is a second planetary gear assembly or a second cam.

17. The fastener driving machine according to claim 15, wherein the first engaging mechanism further comprises an output shaft, both the first engaging structure and the second engaging structure are mounted on the output shaft and rotate with the output shaft, the first engaging structure and the second engaging structure are misaligned along an axial direction of the output shaft.

18. The fastener driving machine according to claim 17, wherein during a rotation of the output shaft, the first engaging structure is periodically engaged with or disengaged from the first mating structure, and the second engaging structure is periodically engaged with or disengaged from the second mating structure.

19. The fastener driving machine according to claim 18, wherein the first engaging structure is engaged with the first mating structure so that the driving unit drives the impact unit to move, and the second engaging structure is engaged with the second mating structure so that the driving unit drives the impact unit to move; during one rotating period of the output shaft, a rotating angle of the first engaging structure is less than 180 degrees during a process of the first engaging structure is maintaining an engagement with the first mating structure, and a rotating angle of the second engaging structure is less than 180 degrees during a process of the second engaging structure is maintaining an engagement with the second mating structure.

20. The fastener driving machine according to claim 15, wherein the second engaging mechanism further comprises a base, and the impact unit further comprises a firing pin connected to the base, the firing pin is used to drive the fastener into the workpiece along the first direction, the first mating structure and the second mating structure are arranged on the base.
